(19) United States
(12) Patent Application Publication
(10) Pub. No.: US 2003/0192166 A1
(43) Pub. Date: Oct. 16, 2003

(54) Disk pack balancing method using spindle hub vibration

(76) Inventor: Bradley D. Kelemen, Longmont, CO (US)

Correspondence Address: MERCHANT & GOULD PC, P.O. BOX 2903, MINNEAPOLIS, MN, 55402-0903, US

(21) Appl. No.: 10/427,477

(22) Filed: Apr. 30, 2003

Related U.S. Application Data
(62) Division of application No. 09/698,457, filed on Oct. 27, 2000, now abandoned.
(60) Provisional application No. 60/169,016, filed on Dec. 3, 1999.

(51) Int. Cl. G11B 5/127; G11B 17/08

(52) U.S. Cl. 29/603.03; 360/98.08

(57) ABSTRACT

A data storage disc or a disc pack containing one or more discs and spacers can be balanced on a spindle hub of a spin motor in a disc drive simply and economically by means of vibrational centering of the disc around the spindle hub. It has been determined that after the disc or disc pack has been placed on the spindle hub, the spindle hub can be vibrated such that the disc or disc pack are centered on the spindle hub, thus balancing the mass of the disc or disc pack on the spindle hub. The balanced disc or disc pack can then be firmly fastened to the spindle hub.

### RELATED APPLICATIONS

This application is a divisional of U.S. patent application Ser. No. 09/698,457, filed Oct. 27, 2000, which claims priority of U.S. provisional application Serial No. 60/169,016, filed on Dec. 3, 1999.

### FIELD OF THE INVENTION

This application relates generally to disc drives and more particularly to disc drives having data discs stacked together to form a disc stack assembly or disk pack on a drive motor. More specifically, the invention relates to a method for balancing the disc pack assembly during manufacture of the disc drive.

### BACKGROUND OF THE INVENTION

Disc drives are data storage devices that store digital data in magnetic form on a rotating storage medium on a disc. Modern disc drives comprise one or more rigid discs that are typically coated with a magnetizable medium and mounted on the hub of a spin motor for rotation at a constant high speed. Information is stored on the discs in a plurality of concentric circular tracks typically by transducers (“heads”) mounted to an actuator assembly for movement of the heads relative to the discs. During a write operation, data is written onto the disc track and during a read operation the head senses the data previously written on the disc track and transfers the information to the external environment. Critical to both of these operations is the accurate locating of the head over the center of the desired track.

The heads are each mounted via flexures at the ends of actuator arms that project radially outward from the actuator body or “E” block. The actuator body typically pivots about a shaft mounted to the disc drive housing adjacent the outer extreme of the discs. The pivot shaft is parallel to the axis of rotation of the spin motor and the discs, so that the heads move in a plane parallel to the surfaces of the discs.

Typically, such actuator assemblies employ a voice coil motor to position the heads with respect to the disc surfaces. The voice coil motor typically includes a flat coil mounted horizontally on the side of the actuator body opposite the actuator arms. The coil is immersed in a vertical magnetic field of a magnetic circuit comprising one or more permanent magnets and vertically spaced apart magnetically permeable pole pieces. When controlled direct current (DC) is passed through the coil, an electromagnetic field is set up which interacts with the magnetic field of the magnetic circuit to cause the coil to move in accordance with the well-known Lorentz relationship. As the coil moves, the actuator body pivots about the pivot shaft and the heads move across the disc surfaces. The actuator thus allows the head to move back and forth in an arcuate fashion between an inner radius and an outer radius of the discs.

Modern disc drives typically include one or more discs and spacers mounted to the rotatable spindle hub of a spin motor. Spacers are used to provide the separation between discs necessary for the actuator arms to movably locate the heads in relation with the disc surfaces. The spin motor spindle hub fits through a central aperture in the discs and spacers and has a flange upon which the discs and spacers rest. The discs and spacers collectively form a disc pack, or disc stack assembly, that is mounted on the spindle hub. The disc pack is held tightly against the hub flange with a disc clamp that is fastened to the upper end of the spindle hub opposite the hub flange.

While the tolerances on a disc pack are close, the central aperture in each of the discs and spacers is slightly larger than the outer diameter of the spindle hub. As a result, the discs and spacers are typically not exactly concentric with the spindle hub after installation. If the disc pack, or a portion thereof, is not concentrically mounted, or balanced, on the spindle hub, then rotation of the spindle hub and attached disc pack will result in an induced precessional torque on the spindle hub. This induced torque can deflect the rotating spindle hub and cause it to precess about the original location of the spindle hub.

Typically, a rotating spindle hub can precess in two distinct ways. Single-plane imbalance of the disc pack will cause the spindle hub to move about or orbit its original location but remain parallel to the original spindle hub axis, i.e. the axis of the spindle hub before being acted on by the precessional torque. Thus, single-plane imbalance in the disk pack would cause the spindle hub to move away from and then closer to the actuator's pivot shaft, but the spindle hub would remain parallel to the pivot shaft. Two-plane imbalance of the disc pack, on the other hand, causes the spindle hub to move such that the spindle hub axis is no longer parallel with the original spindle hub axis and pivot shaft as well as moving it about the original spindle hub axis. Two-plane imbalance also causes the heads to fly at varying heights during drive operation while attempting to follow a precessing disc. Both types of imbalance result in disc movement relative to the heads during disc rotation and lead to undesirable variations in the read/write signals detected and written by the heads of the disc drive. If the imbalance is too great, the signals used to read and write data on the discs may be inadequate to ensure reliable data storage and recovery. Further, imbalance can cause undesirable acoustic noise, chassis vibrations, and accelerated wear of the spindle hub bearing.

Current methods for balancing a disc pack on a spindle hub include the testing of each disc drive after spin motor and disc pack assembly and subsequent addition of weights to the hub or the disc pack in an attempt to offset imbalances due to the position of the disc pack. This method is undesirable because the weights add cost to the drive and the process of testing the drives and adding the weights is time consuming and difficult. Another method is to bias the elements of the disc pack, but this method cannot achieve precise single-plane balance and frequently makes the two-plane balance of the disc pack worse. Yet another method is to directly measure the imbalance in the disc drive and physically strike a portion of the disc pack or the drive itself at a precise time while the discs are spinning in order to cause the disc pack to move relative to the spindle hub. This method frequently makes the two-plane balance worse and is a time consuming and difficult method for achieving single-plane balancing.

Accordingly, there is a need for a method to quickly and simply balance the discs and spacers in a disc pack while on the spindle hub of the spin motor.

### SUMMARY OF THE INVENTION

Against this backdrop the present invention has been developed. Single-plane and two-plane balance of disc packs can be achieved through the use of vibration centering of the disc pack while on the spin motor spindle hub. Vibrating the disc drive before the disc pack is firmly fastened to the spin motor centers the disc pack around the spindle hub of the spin motor, after which the disc pack is firmly fastened in place. This method can be easily and inexpensively integrated into the manufacturing process. Furthermore, the method does not require any balance testing of the drive or the use of additional parts or labor during the manufacturing process because the method can be automated.

Accordingly, one aspect of the invention is found in a method of balancing a disc pack on a spin motor spindle hub by vibrating the spin motor. The method includes the steps of placing the disc pack on the spin motor spindle hub, loosely securing the disc pack, and then vibrating the spin motor in random directions within the plane of rotation of the disc pack. The magnitude and frequency of the vibrations are such that the diameter of the spindle hub is effectively increased to that of the aperture of the disc pack. Therefore, when the vibrations cease, the disc pack is effectively centered about the spindle hub at which time the drive is balanced and the disc pack is firmly fastened to the spindle hub.

These and various other features as well as advantages which characterize the present invention will be apparent from a reading of the following detailed description and a review of the associated drawings.

### BRIEF DESCRIPTION OF THE DRAWINGS

FIG. 1 is a plan view of a disc drive incorporating a preferred embodiment of the present invention showing the primary internal components.

FIG. 2 is a cross-sectional view through the center of a disc pack mounted on a spin motor spindle hub in a plane parallel the axis of rotation of the spin motor.

FIG. 3 is a cross-sectional view showing a disc pack mounted on a spin motor spindle hub in a plane perpendicular to the axis of rotation of the spin motor.

FIG. 4 is a cross-sectional view in a plane perpendicular to the axis of rotation of the spin motor spindle hub showing the vibration of the spin motor in accordance with a preferred embodiment of the present invention.

FIG. 5 is a cross-sectional view in a plane perpendicular to the axis of rotation of the spin motor spindle hub showing the results of the vibration on the spin motor on the position of the disc pack in accordance with a preferred embodiment of the present invention.

### DETAILED DESCRIPTION

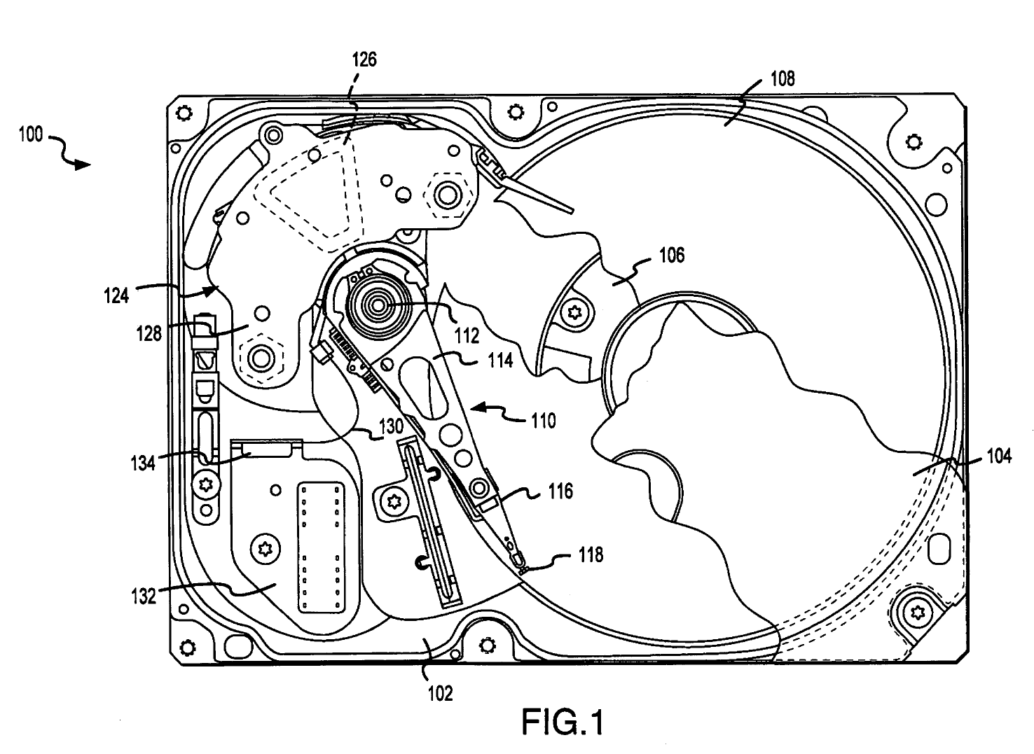

A disc drive 100 constructed in accordance with a preferred embodiment of the present invention is shown in FIG. 1. The disc drive 100 includes a base 102 to which various components of the disc drive 100 are mounted. A top cover 104, shown partially cut away, cooperates with the base 102 to form an internal, sealed environment for the disc drive in a conventional manner. The components include a spin motor 106 that rotates one or more discs 108 and spacers (not shown) at a constant high speed. Information is written to and read from tracks on the discs 108 through the use of an actuator assembly 110, which rotates during a seek operation about a bearing shaft assembly 112 positioned adjacent the discs 108. The actuator assembly 110 includes a plurality of actuator arms 114 which extend towards the discs 108, with one or more flexures 116 extending from each of the actuator arms 114. Mounted at the distal end of each of the flexures 116 is a head 118 that includes an air bearing slider enabling the head 118 to fly in close proximity above the corresponding surface of the associated disc 108.

During a seek operation, the track position of the heads 118 is controlled through the use of a voice coil motor (VCM) 124, which typically includes a coil 126 attached to the actuator assembly 110, as well as one or more permanent magnets 128 which establish a magnetic field in which the coil 126 is immersed. The controlled application of current to the coil 126 causes magnetic interaction between the permanent magnets 128 and the coil 126 so that the coil 126 moves in accordance with the well-known Lorentz relationship. As the coil 126 moves, the actuator assembly 110 pivots about the bearing shaft assembly 112, and the heads 118 are caused to move across the surfaces of the discs 108.

The spin motor 106 is typically de-energized when the disc drive 100 is not in use for extended periods of time. The heads 118 are moved over park zones near the inner diameter of the discs 108 when the drive motor is de-energized. The heads 118 are secured over the park zones (not shown) on the discs 108 through the use of an actuator latch arrangement 122, which prevents inadvertent rotation of the actuator assembly 110 when the heads are parked.

A flex assembly 130 provides the requisite electrical connection paths for the actuator assembly 110 while allowing pivotal movement of the actuator assembly 110 during operation. The flex assembly includes a printed circuit board 132 to which head wires (not shown) are connected; the head wires being routed along the actuator arms 114 and the flexures 116 to the heads 118. The printed circuit board 132 typically includes circuitry for controlling the write currents applied to the heads 118 during a write operation and a preamplifier for amplifying read signals generated by the heads 118 during a read operation. The flex assembly terminates at a flex bracket 134 for communication through the base deck 102 to a disc drive printed circuit board (not shown) mounted to the bottom side of the disc drive 100.

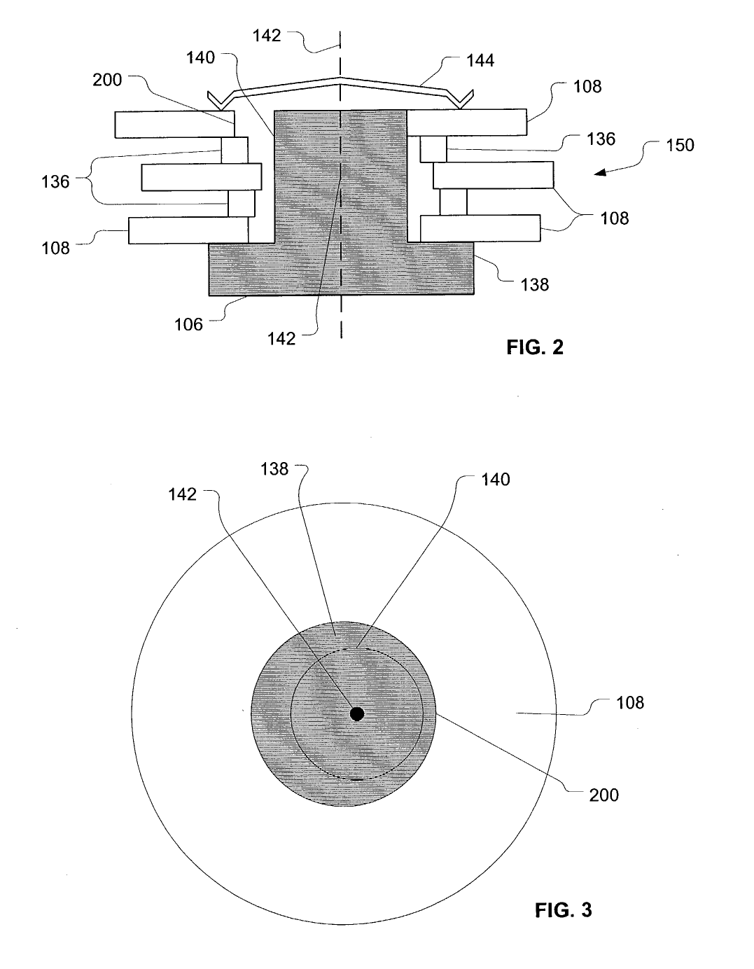

FIG. 2 shows a disc pack 150 consisting of several discs 108 and spacers 136 mounted on a spin motor 106 as seen in a typical disc drive 100. The disc pack 150 can consist solely of one disc 108, or any combination of discs 108 and spacers 136 depending on the type of disc drive 100. The spin motor 106 includes a cylindrical spindle hub 140 that rotates about a central axis 142. The length of the spindle hub 140 can vary depending on the number of discs 108 and spacers 136 in the disc pack 150. At one end of the spindle hub 140 is a flange 138 upon which the disc pack 150 rests. At the other end of the spindle hub 140 are one or more holes (not shown) for fastening a leaf-spring clamp 144 or other means for firmly holding the disc pack 150 against the flange 138. The discs 108 and spacers 136 in the disc pack 150 have central apertures 200 for mounting onto the spindle hub 140 of the spin motor 106. Typically, the diameter of the central apertures 200 is approximately 100 microns or more greater than the diameter of the spindle hub 140 to facilitate mounting during manufacture.

As shown in FIGS. 2 and 3, in typical manufacturing processes, the discs 108 and spacers 136 of the disc pack 150 are randomly spaced about the spindle hub 140. Even though the difference between spindle hub 140 diameter and central aperture 200 diameters is small, if any element of the disc pack 150 is not centered about the location of the central axis 142, it is enough to unbalance the disc drive 100 and impair the drive's performance. Furthermore, if a disc 108 is not centered on the central axis 142, then the heads 118 do not maintain a fixed position over the tracks 120 of the disc 108 when the disc 108 is rotated.

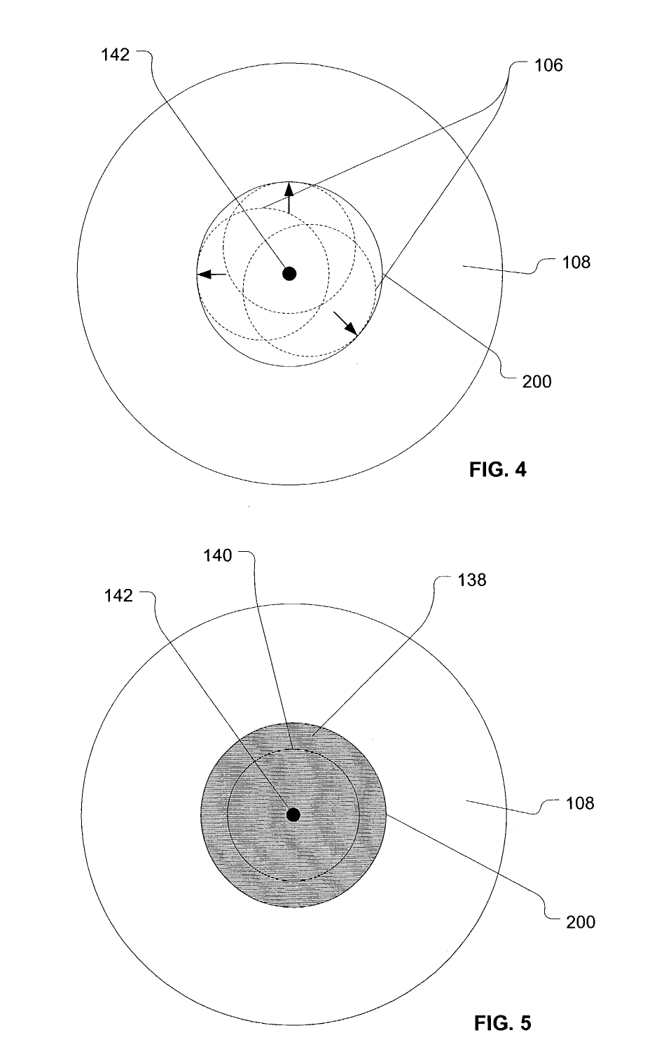

As shown in FIG. 4, a preferred embodiment of the invention is a method to center the elements of a disc pack 150 mounted on a spindle hub 140 about the central axis 142 of the spin motor 106 using vibration. The method consists of loosely mounting the disc pack 150 on the spindle hub 140 of the spin motor 106 and then vibrating the spin motor 106. The vibrations periodically displace the spindle hub a uniform distance from an initial fixed reference point. The direction of each displacement from the initial fixed reference point is randomly selected but within a plane perpendicular to the central axis 142 of the spindle hub 140. The zero to peak magnitude, or distance, of each movement is approximately equal to half the difference between the diameter of the central aperture 200 of the elements of the disc pack 150 and the diameter of the spindle hub 140. The frequency of the vibrations are such that the spindle hub 140 is displaced but the elements of the disc pack 150 only move if they are impacted by the spindle hub 140 as it vibrates. Thus, any disc 108 or spacer 136 that is not centered on the spindle hub 140 will be impacted during vibration of the spin motor 106 and moved into a centered position about the central axis 142, as shown in FIG. 5. This method not only centers the elements of the disc pack 150, but also effectively balances the mass of the disc pack 150 on the spindle hub 140.

Another preferred embodiment of the invention includes lightly fastening the disc clamp 144 to the spindle hub 140 after mounting the disc pack 150 on the spindle hub 140 of the spin motor 106 such that the spindle hub 140 remains free to move in the plane perpendicular to the central axis 142 relative to the disc pack 150. This aids in retaining the disc pack 150 on the spindle hub 140 during the vibration step. After the vibration step is completed, the disc clamp 144 is firmly fastened to the spindle hub 140 fixing the elements of the disc pack 150 in a centered position about the central axis 142.

In a preferred embodiment, the entire disc drive 100 is vibrated to center the elements of the disc pack 150 on the spindle hub 140 as a step within the disc drive 100 manufacturing process.

In summary, a preferred embodiment of the invention may be viewed as a method for centering and balancing a data storage disc (such as 108) placed on a flanged hub (such as 140) of a spin motor (such as 106) in a disc drive (such as 100). For a data storage disc (such as 108) with an inner diameter defining a central aperture (such as 200) slightly larger than an outer diameter of the hub (such as 140), the method involves the steps of placing a disc (such as 108) on a spin motor hub (such as 140) such that the hub (such as 140) passes through the central aperture (such as 200) of disc (such as 108) and vibrating the spin motor hub (such as 140) to center and balance the disc (such as 108).

The hub (such as 140) is vibrated in random directions within the plane perpendicular to the axis of hub rotation (such as 142) at a frequency that moves the hub (such as 140) relative to the data storage disc (such as 108). The zero to peak magnitude of the vibrations are such that the hub (such as 140) is displaced by a distance that is substantially equal to half the difference between the diameter of the central aperture (such as 200) of the data storage disc (such as 108) and the outside diameter of the hub (such as 140). The data storage disc (such as 108) is loosely retained on the hub (such as 140) during vibration by a lightly fastened disc clamp (such as 144) that allows the hub (such as 140) to move relative to the disc (such as 108) while vibrating. After the disc (such as 108) is centered, the disc clamp (such as 144) is fastened clamping the disc (such as 108) to the hub (such as 140). The method may also be used to center a disc pack (such as 150) comprised of one or more discs (such as 108) and spacers (such as 136) mounted on the hub (such as 140) of the spin motor (such as 106). In a preferred embodiment, the spin motor (such as 106) is operated during the vibrating step and the disc drive (such as 100) is vibrated.

Alternatively, the invention also may be viewed as a disc drive (such as 100) that has a data storage disc (such as 108) mounted and centered on a spin motor hub (such as 140) wherein the data storage disc (such as 108) is centered on the hub (such as 140) by vibrating spin motor hub (such as 140) and disc (such as 108) assembly prior to fastening the disc (such as 108) to the hub (such as 140). The disc (such as 108) may have a single disc (such as 108) or a disc pack (such as 150) made up of several data storage discs (such as 108) and spacers (such as 136). The vibration may be applied to the spin motor hub (such as 140) before it is installed in the disc drive (such as 100) or to the disc drive (such as 100) after the spin motor hub (such as 140) has been installed.

It will be clear that the present invention is well adapted to attain the ends and advantages mentioned as well as those inherent therein. While a presently preferred embodiment has been described for purposes of this disclosure, various changes and modifications may be made which are well within the scope of the present invention. For example, the disc clamp may also be centered and balanced on the spindle hub using the same method prior to the disc clamp being fastened to the spindle hub. Numerous other changes may be made which will readily suggest themselves to those skilled in the art and which are encompassed in the spirit of the invention disclosed and as defined in the appended claims.

What is claimed is:

1. A method for centering and balancing a data storage disc placed on a flanged hub of a spin motor for use in a disc drive, the data storage disc having an inner diameter defining a central aperture slightly larger than an outer diameter of the hub, the method comprising steps of:
(a) placing a disc on a spin motor hub such that the hub passes through the central aperture of disc; and
(b) vibrating the spin motor hub in a vibrational plane perpendicular to an axis of hub rotation to center and balance the disc.

2. The method of claim 1 wherein the vibrating step (b) further comprises vibrating the hub in random directions within the vibrational plane perpendicular to the axis of hub rotation.

3. The method of claim 1 wherein the vibrating step (b) further comprises vibrating the hub at a frequency that moves the hub relative to the data storage disc.

4. The method of claim 1 wherein the vibrating step (b) further comprises vibrating the hub at a zero to peak magnitude such that the vibrations displace the hub by a distance that is substantially equal to half the difference between the diameter of the central aperture of the data storage disc and the outside diameter of the hub.

5. The method of claim 1 wherein the placing step (a) includes lightly fastening a disc clamp on the hub to loosely retain the data storage disc on the hub when the hub is vibrated in step (b) while allowing the hub to move relative to the disc while vibrating in the vibrating step (b).

6. The method of claim 5 further comprising:
(c) clamping the disc to the hub after centering the disc on the hub in the vibrating step (b).

7. The method of claim 1 wherein the placing step (a) further comprises placing a spacer and another data storage disc on the hub of the spin motor.

8. The method in claim 1 wherein the vibrating step (b) includes operating the spin motor while the hub is vibrated.

9. The method of claim 1 wherein the spin motor and hub is first installed in a disc drive and the vibrating step (b) further comprises vibrating the spin motor by vibrating the disc drive.

10. A method of disc drive assembly comprising:
installing a spin motor on a disc drive base plate, the spin motor having a generally cylindrical hub having a bottom circumferential flange;
placing a data storage disc having a central aperture having an inner diameter larger than an outer diameter of the cylindrical hub on the flange; and
vibrating the spin motor hub in a vibrational plane perpendicular to an axis of hub rotation to center the disc on the flange of the hub.

11. The method according claim 10 further comprising fastening a disc clamp to the hub to clamp the vibrationally centered disc to the flange of the hub.

12. The method according to claim 11 wherein placing a data storage disc further includes placing a spacer ring on the hub having an inner diameter greater than the outer diameter of the cylindrical hub on the hub over the data storage disc.

13. The method according to claim 12 further comprising placing another disc having an inner diameter larger than the outer diameter of the cylindrical hub on the spacer ring beneath the clamp prior to vibrating the spin motor hub.

14. A method of disc drive assembly comprising:
providing a spin motor having a generally cylindrical hub having a bottom circumferential flange;
placing a data storage disc having a central aperture having an inner diameter larger than an outer diameter of the cylindrical hub on the flange;
vibrating the spin motor hub in a vibrational plane perpendicular to an axis of hub rotation to center the disc on the flange of the hub; and
installing the spin motor carrying the vibrationally centered disc on a base plate in a disc drive.

15. The method according claim 14 further comprising fastening a disc clamp to the hub to clamp the vibrationally centered disc to the flange of the hub prior to installing the spin motor on the base plate.

16. The method according to claim 15 wherein placing a data storage disc further includes placing a spacer ring on the hub having an inner diameter greater than the outer diameter of the cylindrical hub on the hub over the data storage disc prior to vibrating the spin motor hub.

17. The method according to claim 16 further comprising placing another disc having an inner diameter larger than the outer diameter of the cylindrical hub on the spacer ring beneath the clamp prior to vibrating the spin motor hub.
